(19) United States
(12) Patent Application Publication
(10) Pub. No.: US 2008/0220316 A1
(43) Pub. Date: Sep. 11, 2008

(54) End cap seal assembly for a lithium cell

(76) Inventors: Fred J. Berkowitz, New Milford, CT (US); Jaroslav Janik, Southbury, CT (US); Stephen A. Benoit, Southbury, CT (US); Boris Makovetski, Danbury, CT (US); Robert Pavlinsky, Oxford, CT (US); Mark D. Andrews, Roxbury, CT (US); William J. Wandeloski, New Milford, CT (US)

Correspondence Address: MR. BARRY D. JOSEPHS;ATTORNEY AT LAW, 19 NORTH STREET, SALEM, MA, 01970, US

(21) Appl. No.: 11/714,373

(22) Filed: Mar. 6, 2007

(51) Int. Cl. H01M 2/12

(52) U.S. Cl. 429/56

(57) ABSTRACT

An end cap assembly for a primary lithium cell is disclosed. The end cap has a principal application in closing and sealing a primary lithium cell having wound electrodes. The cell may typically have an anode comprising lithium and a cathode comprising iron disulfide (FeS₂). The end cap assembly has a metal cathode contact cup therein having a closed end and opposing open end with integral side walls therebetween. The cathode contact cup is electrically connected to the cathode and is within the electrical pathway between the cathode and terminal end cap. The cathode contact cup has one or more grooves formed at the closed end thereof resulting in thinned or rupturable portions of remaining metal underlying said grooves. The thin or rupturable remaining metal portions are exposed directly to gas within the cell interior and are designed to rupture when gas within the cell builds to a predetermined level.

### FIELD OF THE INVENTION

The invention relates to an end cap assembly for sealing electrochemical cells, particularly lithium primary cells having wound electrodes, more particularly lithium wound cells having an anode comprising lithium and a cathode comprising iron disulfide. The invention relates to rupturable devices within the end cap assembly which allow gas to escape from the interior of the cell to the environment.

### BACKGROUND

Primary (non-rechargeable) electrochemical cells having an anode of lithium are known and are in commercial use. The cell casing, commonly of steel, may typically be cylindrical having an open end and opposing closed end. The anode is comprised essentially of lithium metal. Such cells typically have a cathode comprising manganese dioxide, and electrolyte comprising a lithium salt such as lithium trifluoromethane sulfonate (LiCF₃SO₃) dissolved in a nonaqueous solvent. The cells are referenced in the art as primary lithium cells (primary Li/MnO₂ cells) and are generally not intended to be rechargeable. They are typically in the form having spirally wound electrodes, that is, a sheet of anode material, a sheet of cathode material, and electrolyte permeable separator therebetween spirally wound before insertion into the cell casing.

Alternative primary lithium cells with lithium metal anodes but having different cathodes are also known. Such cells, for example, have cathodes comprising iron disulfide (FeS₂) and are designated Li/FeS₂ cells. The iron disulfide (FeS₂) is also known as pyrite. The Li/MnO₂ cells or Li/FeS₂ cells are typically in the form of cylindrical cells, typically an AA size cell or ⅔A size cell, with a sheet of anode material, separator, and sheet of cathode material spirally wound before insertion into the cell casing. The Li/MnO₂ cells have a voltage of about 3.0 volts which is twice that of conventional Zn/MnO₂ alkaline cells and also have higher energy density (watt-hrs per cm³ of cell volume) than that of alkaline cells. The Li/FeS₂ cells have a voltage (fresh) of between about 1.2 and 1.5 volts which is about the same as a conventional Zn/MnO₂ alkaline cell. However, the energy density (watt-hrs per cm³ of cell volume) of the Li/FeS₂ cell is also much higher than a comparable size Zn/MnO₂ alkaline cell. The theoretical specific capacity of lithium metal is high at 3861.7 mAmp-hr/gram and the theoretical specific capacity of FeS₂ is 893.6 mAmp-hr/gram. The FeS₂ theoretical capacity is based on a 4 electron transfer from 4Li per FeS₂ to result in reaction product of elemental iron Fe and 2Li₂S. That is, 2 of the 4 electrons reducing the valence state of Fe⁺² in FeS₂ to Fe and the remaining 2 electrons reducing the valence of sulfur from −1 in FeS₂ to −2 in Li₂S.

Overall the Li/FeS₂ cell is more powerful than the same size Zn/MnO₂ alkaline cell. That is for a given continuous current drain, particularly for higher current drain over 200 milliAmp, in the voltage vs. time profile the voltage drops off much less quickly for the Li/FeS₂ cell than the Zn/MnO₂ alkaline cell. This results in a higher energy obtainable from a Li/FeS₂ cell compared to that obtainable for a same size alkaline cell. The higher energy output of the Li/FeS₂ cell is also clearly shown more directly in graphical plots of energy (Watt-hrs) versus continuous discharge at constant power (Watts) wherein fresh cells are discharged to completion at fixed continuous power outputs ranging from as little as 0.01 Watt to 5 Watt. In such tests the power drain is maintained at a constant continuous power output selected between 0.01 Watt and 5 Watt. (As the cell's voltage drops during discharge the load resistance is gradually decreased raising the current drain to maintain a fixed constant power output.) The graphical plot Energy (Watt-Hrs) versus Power Output (Watt) for the Li/FeS₂ cell is considerably above that for the same size Zn/MnO₂ alkaline cell. This is despite that the starting voltage of both cells (fresh) is about the same, namely, between about 1.2 and 1.5 volt.

Thus, the Li/FeS₂ cell has the advantage over same size alkaline cells, for example, AAA (44×10 mm), AA (50×14 mm), C (49×25.5 mm) or D (60×33 mm) size or any other size cell in that the Li/FeS₂ cell may be used interchangeably with the conventional Zn/MnO₂ alkaline cell and will have greater service life, particularly for higher power demands. Similarly the Li/FeS₂ cell which is primary (nonrechargeable) cell can be used as a replacement for the same size rechargeable nickel metal hydride cells, which have about the same voltage (fresh) as the Li/FeS₂ cell.

After the spirally wound electrodes for the Li/FeS₂ cell are inserted into the typically cylindrical casing, electrolyte is added, and the open end of the casing must then be closed with an end cap assembly. The end cap assembly is multifunctional. There is a terminal end cap or end plate within the end cap assembly which provides a contact terminal. For the Li/FeS₂ cell the end cap is in electrical contact with cell's cathode and provides the cell's positive terminal. The end cap assembly must include a reliable seal to prevent leakage of electrolyte and withstand levels of cell internal pressure due to gassing during cell storage or discharge. The cell should include a venting system which is activated when gas pressure within the cell builds up to predetermined level. The venting system is desirably included within the end cap assembly.

The electrochemical cell art discloses vents that may be formed within the cell casing wall itself, that is, by weakening the casing wall so that it will rupture when the cell internal pressure reaches a given level. The art teaches that this may be achieved by scoring or etching the cell metal casing wall to provide a thinned rupturable portion within the casing wall itself. Such scored regions are shown in the cell casing side wall or casing bottom (closed end), so that the scored region faces the external environment. Examples of electrochemical cells which disclose such scored or weakened regions on the cell casing wall are U.S. Pat. Nos. 2,478,798; U.S. Pat. No. 2,525,436; U.S. Pat. No. 4,484,691; U.S. Pat. No. 4,256,812; U.S. Pat. No. 4,789,608; U.S. Pat. No. 4,175,166. and U.S. Pat. No. 6,159,631.

In U.S. application 2006/0228620 A1 is shown a wound Li/FeS₂ cell which includes a separate thin metal foil or polymeric membrane within the end cap assembly. The separate membrane is designed to rupture when gas within the cell builds up to a predetermined level.

Electrochemical cells may be provided with a rupturable venting mechanism which typically includes a rupturable membrane integrally formed within a plastic insulating sealing disk, e.g. of nylon, polypropylene or polyethylene, within an end cap assembly. The rupturable membrane may be formed from grooved or thinned portions within the plastic insulating disk as described, for example, in U.S. Pat. No. 3,617,386. Such membranes are designed to rupture when gas pressure within the cell exceeds a predetermined level. The end cap assembly may be provided with vent holes for the gas to escape to the environment when the membrane is ruptured.

The electrochemical cell art discloses rupturable vent membranes which are integrally formed as thinned areas within a plastic insulating sealing disk included within the end cap assembly. Such vent membranes are normally oriented such that they lay in a plane perpendicular to the cell's longitudinal axis, for example, as shown in U.S. Pat. No. 5,589,293. In U.S. Pat. No. 4,227,701 the rupturable membrane is formed of an annular “slit or groove” located in an arm of the insulating disk which is slanted in relation to the cell's longitudinal axis. The plastic insulating disk is slid ably mounted on an elongated current collector running therethrough. As gas pressure within the cells builds up the center portion of the insulating disk slides upwards towards the cell end cap, thereby stretching the thinned membrane “groove” until it ruptures. U.S. Pat. Nos. 6,127,062 and 6,887,614 B2 disclose an insulating sealing disk and an integrally formed rupturable membrane therein which is inclined. The rupturable membrane portion in the sealing disk abuts an aperture in the overlying metal support disk. When the gas pressure within the cell rises the membrane ruptures through the aperture in the metal support disk thereby releasing the gas pressure which passes to the external environment.

U.S. Pat. Nos. 6,127,062 and 6,887,614 B2 disclose a plastic insulating sealing disk and an integrally formed rupturable membrane wherein the rupturable membrane abuts an aperture in the overlying metal support disk. In U.S. Pat. No. 6,887,614 the rupturable membrane is integrally formed within the plastic insulating sealing disk. The rupturable membrane abuts an opening in an overlying metal support disk. In U.S. Pat. No. 6,887,614 there is an undercut groove on the underside of the membrane. The groove circumvents the cell's longitudinal axis. The groove creates a thinned membrane portion at its base which ruptures through the opening in the overlying metal support disk when the cell's internal gas pressure reaches a predetermined level.

The rupturable membrane can be in the form of one or more “islands” of thin material integrally formed within the plastic insulating disk as shown in U.S. Pat. No. 4,537,841; U.S. U.S. Pat. No. 5,589,293; and U.S. Pat. No. 6,042,967. Alternatively, the rupturable membrane as integrally formed within the plastic insulating disk can be in the form of a thin portion circumventing the cell's longitudinal axis as shown in U.S. Pat. No. 5,080,985 and U.S. Pat. No. 6,991,872. The circumventing thinned portion forming the rupturable membrane can be in the form of slits or grooves within the plastic insulating disk as shown in U.S. Pat. No. 4,237,203 and U.S. Pat. No. 6,991,872. The rupturable membrane may also be a separate piece of polymeric film which is sandwiched between the metal support disk and the plastic insulating disk and facing apertures therein as shown in Patent Application Publication US 2002/0127470 A1. A pointed or other protruding member can be oriented above the rupturable membrane to assist in rupture of the membrane as shown in U.S. Pat. No. 3,314,824. When gas pressure within the cell becomes excessive, the membrane expands and ruptures upon contact with the pointed member, thereby allowing gas from within the cell to escape to the environment through apertures in the overlying terminal end cap.

The above described end cap assemblies which include venting mechanisms such as rupturable membranes which are an integral part of a plastic insulating sealing disk are generally not suitable for use in the end cap assembly for wound primary lithium cells because of assembly and connection requirements which are specific to such wound cells.

Accordingly, it is desirable to have an end cap assembly of components that can be readily manufactured and assembled and which provides a tight seal for a wound primary lithium cell during normal operation and extremes in both hot and cold climate.

It is desired to have a reliable rupturable venting mechanism within the end cap assembly which activates and functions reliably in a wound lithium cell when gas pressure within the cell rises to a predetermined level.

It is desirable that the end cap assembly include a current interrupter such as a PTC (positive temperature coefficient) device to provide additional protection against short circuit or abnormally high current drain.

It is desirable that the end cap be tamper proof, that is, cannot be readily pried from the end cap assembly.

### SUMMARY OF THE INVENTION

The invention is directed to an end cap assembly for closing and sealing cells having a wound electrode therein. The end cap assembly is inserted into the open end of the cell casing (housing) to seal and close the casing and also provides a venting device therein which activates should gas pressure within the cell rise to a predetermined level. The venting device preferably includes a rupturable metal surface which is designed to rupture if the gas pressure within the cell builds to a predetermined level. The end cap assembly may also include a current interrupter such as a PTC (positive temperature coefficient) device. The PTC device activates to abruptly increase resistance therethrough to quickly reduce current drain, if the cell is subjected to short circuit, abnormally high current drain or abnormally high temperatures. The end cap assembly of the invention is principally intended for lithium primary (non rechargeable) cells, that is, wherein the anode comprises lithium. The cell may typically have an anode comprising a sheet of lithium or lithium alloy and a cathode comprising manganese dioxide (MnO₂) or iron disulfide (FeS₂). In particular the end cap assembly of the invention has a principal application for primary (nonrechargeable) wound electrode cells wherein the anode comprises a sheet of lithium or lithium alloy and the cathode comprises a layer, normally a coating comprising iron disulfide (FeS₂). The cell casing is typically cylindrical.

In a principal aspect the end cap assembly comprises a metal end cap which forms the positive terminal, and an underlying metal cathode contact cup with an optional PTC (positive temperature coefficient) device therebetween. The cathode contact cup is electrically connected to both the underlying cathode and overlying end cap so that the cathode contact cup becomes a part of the electrical pathway between cathode and end cap. The cathode contact cup has an open end, opposing closed end or base with integral side walls therebetween. The end cap assembly also includes an insulating sealing disk, preferably of plastic, into which the cathode contact cup is inserted so that it is insulated from electrical contact with the cell casing. The insulating sealing disk has an aperture running longitudinally therethrough resulting in a pair of opposing open ends. The aperture is bounded by the side walls or peripheral edge of said insulating sealing disk.

In a principal aspect the cathode contact cup, which is of metal, is provided with an integral rupturable thinned portion which is designed to rupture and thereby release gas therethrough should the cell's internal pressure rise to a predetermined level. The rupturable thinned portion is an integral part of one of the walls of the cathode contact cup, desirably located within the cup's closed end or base facing the cell interior. The thinned portions are preferably formed by impacting a die having a sharp edge onto the closed end of the cathode contact cup. (The die edge may be preheated before impact.) Other methods of forming the thinned portions may be possible and are not excluded. Preferably the die is impacted against the closed end of the cathode contact cup thereby forming grooves therein. The grooves may be segmented or continuous and may be straight or curvilinear or a combination of both. The remaining metal underlying the grooves at the base of said grooves forms the thinned metal portions in the cathode cup closed end. The grooves are preferably made on the side of cathode contact cup closed end facing away from the cell interior. Alternatively, the grooves can be made on the opposite side of the cathode contact closed end, namely on the side facing the cell interior. The remaining metal underlying the grooves in the cathode cup base are designed to be thin enough so that they will rupture when gas pressure within the cell builds up to a predetermined level. A preferred metal for the cathode cup and thus also for the rupturable metal underlying said grooves has been determined to be an alloy of aluminum. The preferred metal of construction for the cathode contact cup is preferably an aluminum alloy that has been subjected to annealing so that it is sufficiently malleable that said rupturable metal portions underlying the grooves can be reliably manufactured at the small thicknesses required. The aluminum alloy also provides excellent electrical conductivity between the cathode material, cathode contact cup, and end cap.

The cathode contact cup desirably has a support disk or washer, preferably of metal, inserted therein to enhance the strength of said cup. The support disk or washer is typically of flat shape with a central aperture. Alternatively, the support disk may be built into the cathode contact cup, that is, formed as an integral part of the cathode contact cup. This in turn increases the annular thickness of the cathode contact cup and eliminates the need for a separate support disk to be inserted therein.

In assembly the wound electrodes are inserted into the cell casing and an insulating cover or insulating washer may be inserted to cover the top of the wound electrodes. An anode tab extending from the anode is welded to the closed end of the casing. The end cap assembly of the invention is formed outside of the casing. In forming the end cap assembly the metal cathode contact cup with optional support disk therein is inserted into the insulating sealing disk. The metal end cap with optional underlying PTC device is then also inserted into the insulating sealing disk over the cathode contact cup, so that the side walls or peripheral edge of said insulating sealing disk extends over the edge of the metal end cap. This completes formation of the end cap assembly. A cathode tab is joined with the base of the cathode contact cup through an opening at the base of the insulating sealing disk. Electrolyte is added to the wound electrodes within the casing. The end cap assembly is then inserted into the cell casing open end to close the casing. The edge of the casing is crimped over the insulating sealing disk peripheral edge which in turn crimps over the end cap assembly permanently locking the end cap assembly in place and tightly sealing the casing.

### BRIEF DESCRIPTION OF THE DRAWINGS

The invention will be better understood with reference to the drawings in which:

FIG. 1 is a pictorial cut-away view of the end cap assembly of the invention.

FIG. 2 is an exploded view showing the components of the end cap assembly of the invention.

FIG. 3 is a pictorial view of the end cap.

FIG. 4 is a pictorial view of the PTC device underlying the end cap.

FIG. 5 is a top perspective view of the support washer.

FIG. 6 is a top perspective view of one embodiment of the cathode contact cup having linear grooves therein forming thin rupturable portions.

FIG. 7 is a top perspective view of a second embodiment of the cathode contact cup having a circumferential groove therein forming thin rupturable portions.

FIG. 8 is a cross sectional view of a representative groove forming a thin rupturable portion in the contact cup surface.

FIG. 9 is a top perspective view of the insulating sealing disk.

FIG. 10 is a first embodiment of the end cap assembly of the invention employing a cathode contact cup inserted into the insulating sealing disk, wherein the cathode contact cup has lined grooves in its bottom surface as in FIG. 6.

FIG. 11 is a second embodiment of the end cap assembly of the invention employing a cathode contact cup inserted into the insulating sealing disk, wherein the cathode cup has a circumferential groove in its bottom surface as in FIG. 7.

FIG. 12 is a top perspective view of a third embodiment of the contact cup wherein the support washer is built into and forms an integral part of the contact cup.

FIG. 13 is a second embodiment of the end cap assembly of the invention wherein the contact cup of FIG. 12 is inserted into the insulating sealing disk.

FIG. 13A is a version of the embodiment of FIG. 13 showing interlocking between the cathode contact cup and sealing disk.

FIG. 14 is a top perspective view of a thicker support washer for insertion into the cathode contact cup.

FIG. 15 is a third embodiment of the end cap assembly of the invention wherein the thicker support washer as in FIG. 14 is employed and the edge of the cathode contact cup is not crimped over said thicker support washer.

FIG. 16 is a schematic showing the placement of the layers comprising the wound electrode assembly.

FIG. 17 is a plan view of the electrode assembly of FIG. 16 with each of the layers thereof partially peeled away to show the underlying layer.

### DETAILED DESCRIPTION

The end cap assembly 14 of the invention has application to wound electrode cells. The principal application for end cap assembly 14 is for use in closing, sealing, providing a venting system, and an electrical safety cut off, for a cylindrical casing (housing) 70. End assembly 14 also provides an end terminal for the cell. The casing 70 may be of a standard cylindrical size AAA (44×10 mm), AA (50×14 mm), C (49×25.5 mm) or D (60×33 mm) or other cell sizes.

The end cap assembly 14 herein described is principally intended for lithium primary (non rechargeable) cells, that is, wherein the anode comprises lithium. The cell may typically have an anode 240 comprising a sheet of lithium and a cathode comprising a coating or layer 260 comprising manganese dioxide (MnO₂) or iron disulfide (FeS₂). Anode 240 can be an alloy of lithium and an alloy metal, for example, an alloy of lithium and aluminum. In such case the alloy metal, is present in very small quantity, preferably less than 1 percent by weight of the lithium alloy. Thus, the term “lithium” or “lithium metal” as used herein and in the claims is intended to include in its meaning such lithium alloy. The lithium sheet forming anode 240 does not require a substrate. The lithium anode 240 can be advantageously formed from an extruded sheet of lithium metal having a thickness desirably between about 0.05 and 0.30 mm.

In particular the end cap assembly 14 of the invention has a principal application for wound electrode cells in particular wound electrode primary (nonrechargeable) cells as in cell 10 wherein the anode 240 comprises a sheet of lithium or lithium alloy and the cathode comprises a coating or layer 260 comprising iron disulfide (FeS₂). The cathode coating 260 comprising FeS₂ powder is desirably applied onto a grid or mesh or foil 265 thus forming a cathode composite 262 sheet (FIG. 16). The spirally wound electrode assembly 213 comprises an anode sheet 240 which is spirally wound together with the cathode composite sheet 262 with an electrolyte permeable separator sheet 250 therebetween. The spirally wound electrode assembly 213 is inserted into cathode casing 70. Electrolyte is added to the wound electrode assembly 213 within casing 70. An anode tab 244 (FIG. 17) extends from the electrode assembly 213 and is joined, for example by welding, to the inside surface of closed end 75 of casing 70. A cathode tab 264 is welded to the closed end 49 of a metal cathode contact cup 40 within end cap assembly 14. The end cap assembly 14 is inserted into the open end 15 of the casing 70 which is typically cylindrical. The peripheral edge 72 of casing 70 is crimped over the end cap assembly 14, preferably while also applying radial compressive forces, thus locking end cap assembly 14 in place and sealing the casing open end 15. End cap 60 which is in electrical connection with cathode cup 40 and cathode 260 functions as the cell's positive terminal and the closed end 72 of casing 70, which is in electrical connection with anode 240, functions as the cell's negative terminal. End cap 60 desirably has a plurality of vent apertures 65 therein which may typically have an opening with an area of about 1 mm² or more.

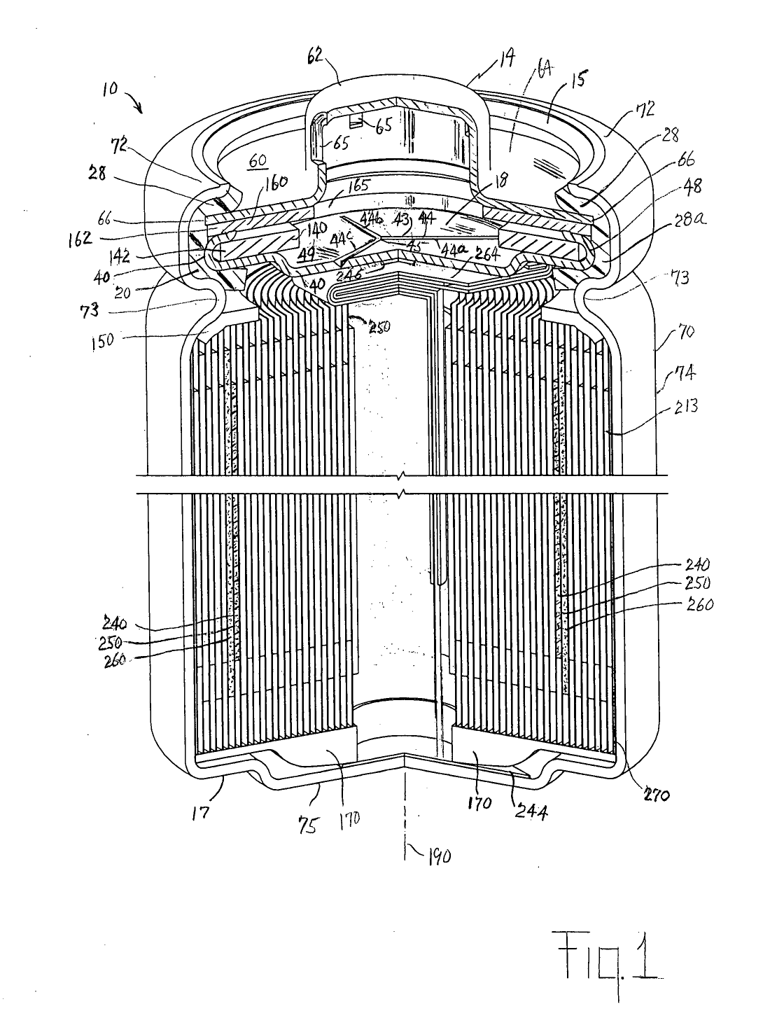

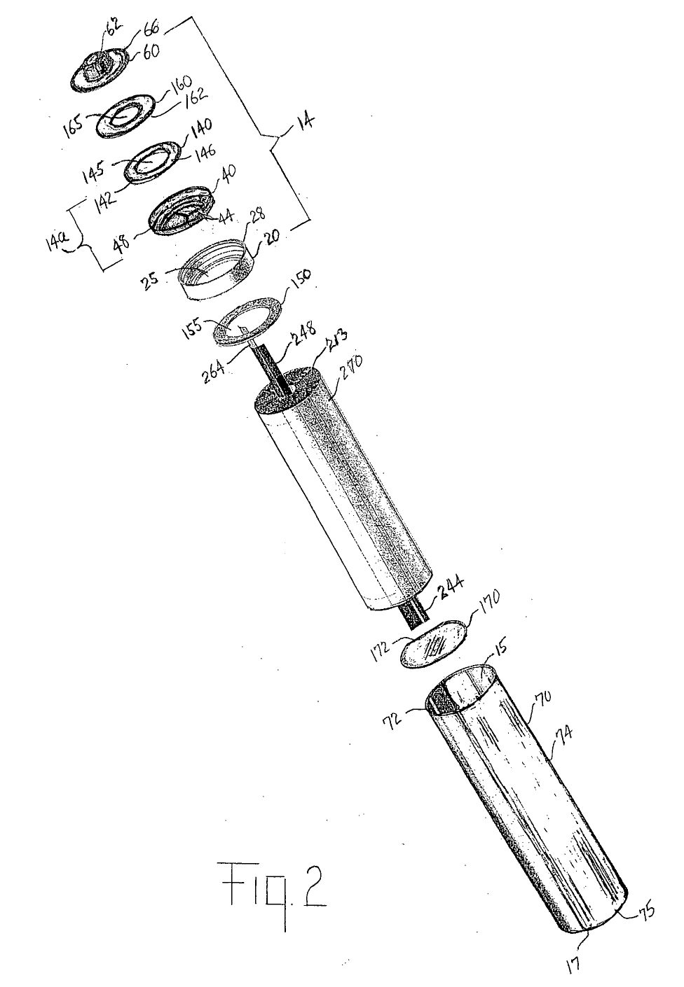

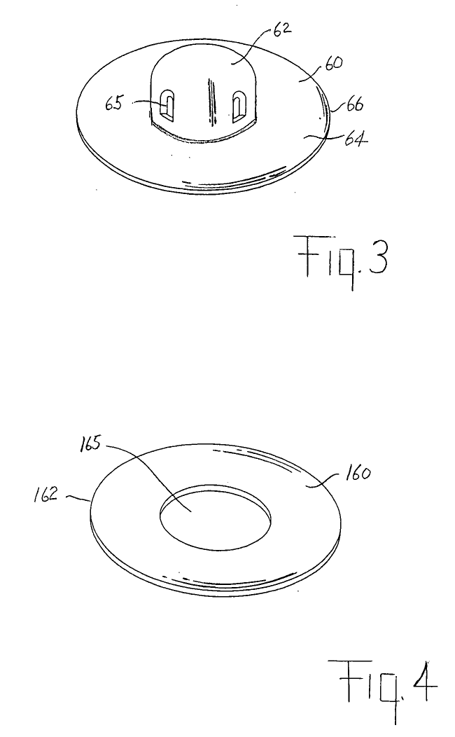

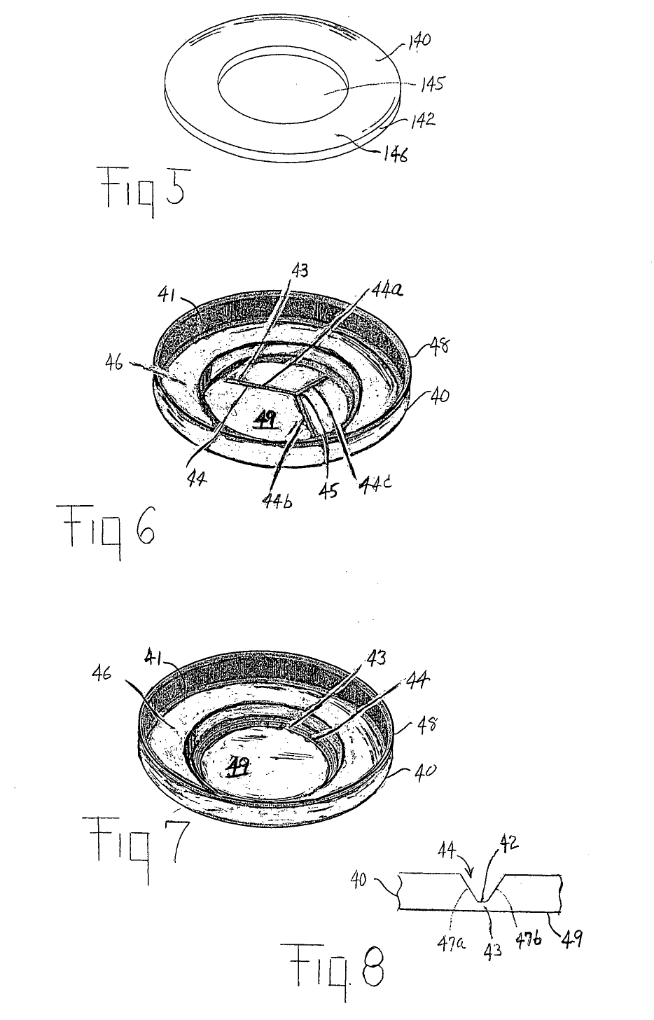

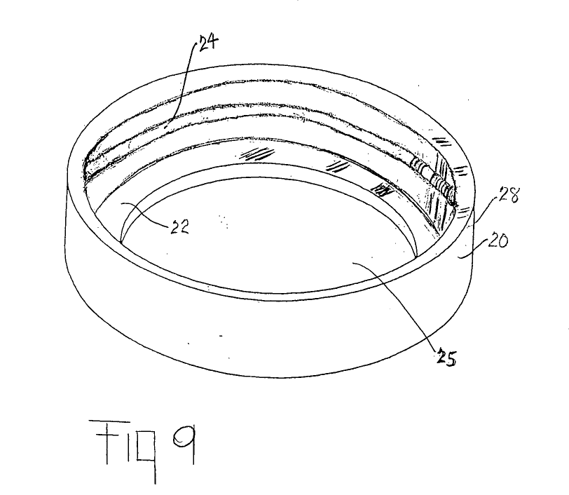

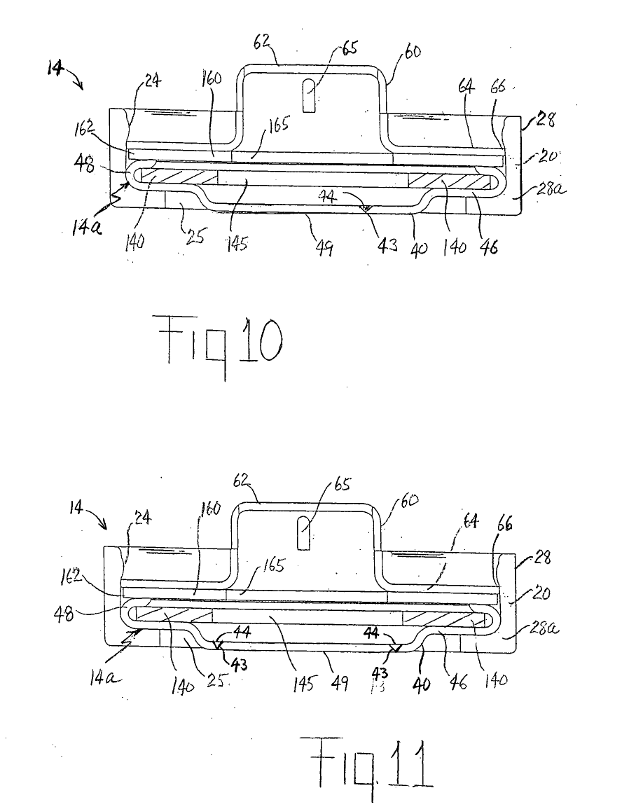

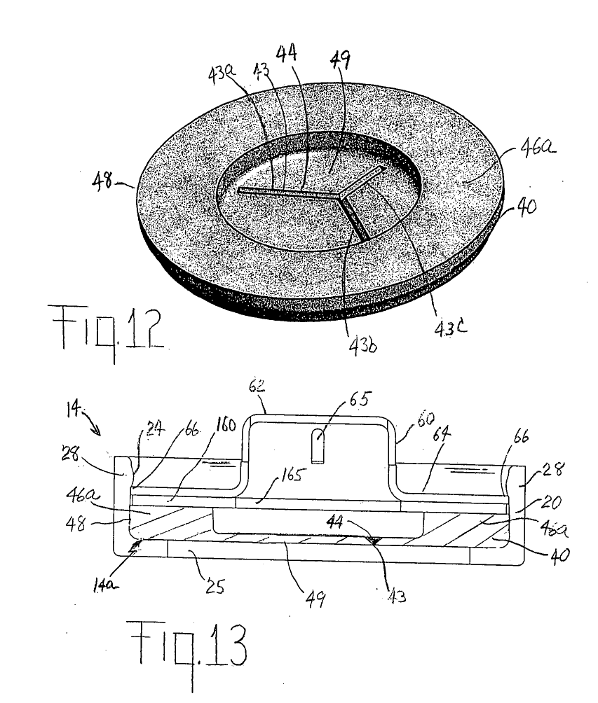

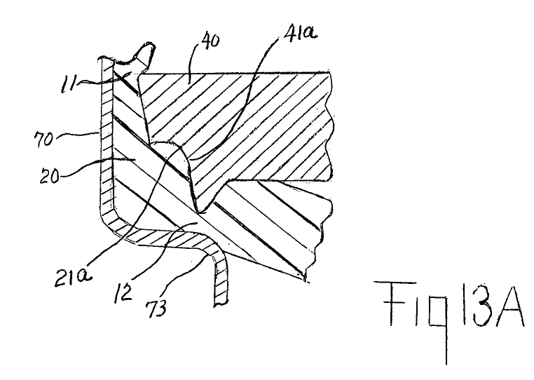

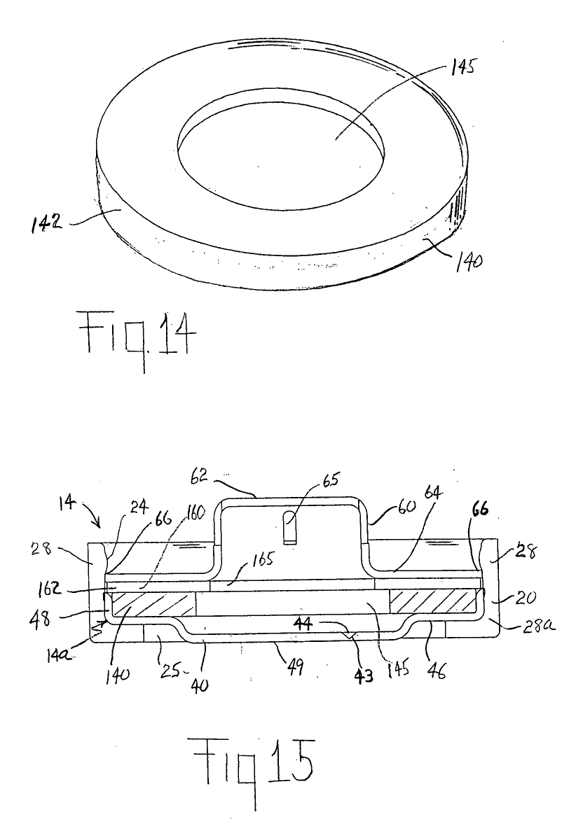

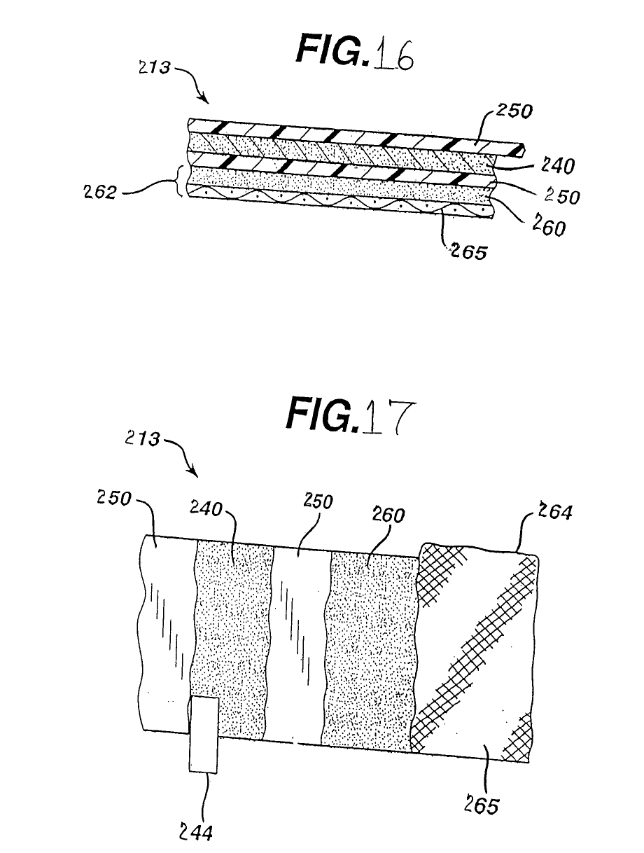

In a principal embodiment end cap assembly 14 (FIGS. 1 and 2) comprises an end cap 60, and an underlying metal cathode contact cup 40, with an optional PTC device 160 (positive temperature coefficient), therebetween. The end cap assembly 14 further includes an insulating sealing disk 20 having a central aperture 25 running longitudinally therethrough thereby forming a pair of opposing open ends (FIG. 9). The cathode contact cup 40 and end cap 60 (with optional PTC device 160) are inserted within the central aperture 25 of insulating sealing disk 20 so that the edge 48 of the cathode contact cup 40, surface 162 of the PTC device 160, and edge 66 of end cap 60 are within peripheral edge 28 of insulating sealing disk 20.

The cathode cup 40 desirably has a support disk or washer 140, preferably of metal, inserted therein as shown in representative FIGS. 1, 10, 11 and 15. The support washer 140 may typically have a thickness between about 0.2 and 1.5 mm (FIG. 5). The metal support washer 140 for an AA cell may typically have a central opening 145 of diameter between about 2 and 9 mm and an outside diameter (O.D.) of about 11 mm. Central opening 145 is bounded by annular region 146 which terminates in surface edge 142. It will be appreciated that the overall diameter of support washer 140 and aperture 145 can be adjusted with cell size. The principal function of support disk 140 is to provide additional strength and prevent excessive deflection of the cathode contact cup 40. Alternatively, support washer 140 may be formed as an integral part of cathode contact cup 40, thus increasing the annular thickness of contact cup 40 as shown, for example, in FIGS. 12 and 13. In this embodiment the closed end or base 49 of the cathode cup may be flat along the entire cup diameter as shown in FIG. 13.

End cap assembly 14 (FIG. 2) also comprises an insulating sealing disk 20 (FIG. 9) preferably of resilient, durable plastic material, preferably of polypropylene. Insulating sealing disk 20 has an aperture 25 running longitudinally therethrough resulting in a pair of opposing open ends as shown in FIG. 9. Aperture 25 is bounded by side walls or peripheral edge 28 (FIG. 9). There may be an insulating washer 150, preferably of durable plastic, which underlies insulating sealing disk 20. Insulating washer 150 is separate from the end cap assembly 14 and it protects and hold the wound electrode assembly 213 in place in cell casing 70.

The metal cathode contact cup 40 may be disk shaped having an open end 41 and opposing closed end or base 49 and integral side walls forming peripheral edge 48 therebetween. The base 49 may be stepped or recessed down from peripheral edge 48 as shown best in FIGS. 10 and 11. For an AA cell the cathode contact cup 40 may typically have an outside diameter (O.D.) of about 12 mm and a stepped base 49 of between about 3 and 9 mm (FIGS. 10 and 11). These dimensions can be adjusted depending on cell size. In the embodiment shown in FIG. 13 cathode contact cup 40 may have a base 49 which is flat over the entire cup diameter so that the annular region 46a may be thicker than in the cathode contact cup 40 embodiments of FIGS. 10 and 11. The cathode contact cup 40 shown in FIG. 13 with thicker annular region 46a thus eliminates the need for a separate metal washer 140 to be inserted therein.

The cathode contact cup 40 is characterized by having one or more thinned portions 43, preferably die cut into base 49. The thinned portions 43 are preferably formed by impacting a die having a sharp edge onto the top surface of the metal cathode contact cup base 49 thereby forming one or more grooves 44 which dig into the surface of said base 49. Grooves 44 have an open end and opposing closed base 42 and side walls 47a and 47b therebetween as shown in FIG. 8. The remaining metal underlying grooves 44 at the base 42 of said grooves forms the thinned portions 43 as shown in FIG. 8. The thinned portions 43 within the metal base 49 of contact cup 40 are designed to be thin enough that they will rupture when gas pressure within the cell builds up to a predetermined level.

The grooves 44 which are formed into the cathode contact cup base 49 may be of varying shape and pattern. The grooves 44 may be continuous or segmented. They may be linear (straight) or curvilinear or a combination of both. There may be one or a plurality of such grooves 44 cut into the cathode cup base 49. The grooves 44 side walls 47a and 47b may be vertical or slanted thus forming a V shape as shown in FIG. 8. Typically, the grooves have V shaped side walls 47a and 47b, wherein said side walls form an angle between about 15 and 150 degrees, desirably between about 30 and 90 degrees, preferably about 60 degree. The burst pressure of the underlying thinned portions 43 (remaining metal) can be adjusted somewhat by adjusting the width of said grooves. However, for a given metal, it has been determined that the principal parameter for obtaining the desired metal burst pressure is the thickness of the remaining metal 43 underlying grooves 44. A suitable metal for the cathode contact cup 40 must be chosen so that a) it is sufficiently resistant to chemical attack by the cell electrolyte, b) it provides good electrical contact with cathode material 260, and c) it is sufficiently malleable so that the desired degree of thinness for remaining metal 43 underlying grooves 44 may be achieved without fracturing base 49. A preferred metal for cathode cup 40 which exhibits these desired qualities has been determined to be an aluminum alloy-material. While various aluminum alloys would be suitable, a preferred aluminum alloy by way of example, contains about 2.5% magnesium and about 0.25% chromium and has been annealed. Such aluminum alloy is available commercially under the ASTM designation 5052-H34 or 5054-H38 aluminum alloy. Other suitable aluminum alloys for cathode contact cup 40 may be selected from the ASTM designated 1000 to 7000 series, preferably aluminum alloys within this series that have been subjected to annealing.

An example of grooves 44 having a straight line pattern is shown in FIG. 6. The grooves in FIG. 6 have three straight line segments 44a, 44b, and 44c in the pattern of straight spokes jutting out from a common point 45 (FIG. 6). Each groove 44a, 44b, and 44c has corresponding underlying remaining metal portions 43 (FIG. 8), which will rupture and thus serve as a vent if gas within the cell builds to a predetermined pressure. The common point 45 is desirably displaced from central longitudinal axis 190 so that it is not directly aligned under welding area between cathode tab 264 and the bottom surface of cathode contact cup 40. In an AA cell for example, common point 45 may typically be displaced about 1 mm from central longitudinal axis 190. The common point 45 can be located on longitudinal axis 190 should the cathode tab 264 be attached to the contact cup 40 elsewhere, that is, outside of longitudinal axis 190.

An example of grooves 44 having a curvilinear pattern is circumferential groove 44 which circumvents the cathode contact cup base 49 as shown best in FIG. 7. It will be appreciated that these patterns are given simply by way of nonlimiting example as many other groove patterns are possible. Such other patterns, for example, could involve a combination of straight and curvilinear shaped grooves which may be arranged in continuous or segmented patterns.

By way of a specific non limiting example, if cell 10 has a lithium or lithium alloy anode 240 and cathode coating 260 comprising iron disulfide (FeS₂), then a suitable rupture pressure for the thin portions 43 underlying grooves 44 for an AA size cell may be between about 50 and 1000 psi (345 and 6894 kilo pascal, desirably between about 300 and 800 psi (2068 and 5515 kilo pascal), preferably between about 350 and 500 psi (2413 and 3447 kilo pascal). In order to achieve such burst pressure in the context of the present invention, a cathode contact cup 40 formed of aluminum alloy (2.5% Mg; 0.25% Cr) can be advantageously employed. Such aluminum alloy, for example, is available under the ASTM designations 5052-H34 or 5052-H38, wherein H is the strain hardening designation. (Other aluminum alloys of different alloy composition and degree of heat treatment could also be sufficiently suitable material for cathode cup 40.) The cathode contact cup 40 wall thickness may typically be between about 0.2 and 1.5 mm. The base 49 portions adjacent grooves 44 (FIG. 8) may typically have a thickness between about 0.2 and 0.3 mm.

When gas pressure within the cell 10 builds up to a predetermined pressure the remaining metal portions 43 underlying grooves 44 in the cathode contact cup base 49 will burst allowing gas from within the cell to escape to the environment through vent apertures 65 in end cap 60.

When the cathode contact cup 40 is formed of the above designated preferred aluminum alloy materials, e.g., ASTM designated 5052-H34 or 5052-H38 aluminum alloy, it has been determined that the remaining metal portion 43 underlying grooves 44 should have a reduced thickness in order to achieve burst pressure in the range between about 50 and 1000 psi (345 and 6894 kilo pascal) or more preferably burst pressures in the range between about 300 and 800 psi (2068 and 5515 kilo pascal) employing the above designated aluminum alloys. In order to achieve burst pressures in the range between about 50 psi and 1000 psi (345 and 6894 kilo pascal), preferably between about 350 and 500 psi (2413 and 3447 kilo pascal) employing the above designated aluminum alloys, the remaining metal portion 43 underlying grooves 44 should have a thickness between about 0.02 and 0.12 mm, typically between about 0.02 and 0.06 mm. More specifically, to achieve a burst pressure between about 350 and 500 psi (2413 and 3447 kilo pascal) when using aluminum alloy 5052-H38 ASTM designation for cathode contact cup 40, a preferred thickness of the remaining metal portion 43 underlying grooves 44 is between about 0.02 and 0.04 mm. When aluminum alloy 5052-H34 ASTM designation is employed for cathode contact cup 40, a preferred thickness of the remaining metal portion 43 underlying grooves 44 is between about 0.04 and 0.06 mm to achieve the same burst pressure between about 350 and 500 psi (2413 and 3447 kilo pascal). The groove width is defined herein as the width of groove 44 at its base 42, that is, at its closed end abutting underlying remaining metal 43 (FIG. 8). The groove width at base 42 may typically be between about 0.1 and 1 mm. The burst pressure of remaining metal 43 may be adjusted somewhat by adjusting the groove width. (Slightly greater groove width would require slightly less burst pressure for a given thickness of underlying remaining metal 43). However, the principal parameter for determining the burst pressure of remaining metal 43 for a given metal, is the thickness of said remaining metal portion 43 underlying groove 44.

The end cap assembly 14 may be provided with a PTC (positive thermal coefficient) device 160 located under the end cap 60 and electrically connected in series between the cathode 260 and end cap 60 (FIG. 1). The PTC device 160 may be in the shape of a flat disk with central aperture 165 (FIG. 4). The PTC device 160 increases electrical resistance therethrough dramatically when exposed to heat caused by electrical resistive heating or an external heat source. Such device protects the cell from discharge at a current drain higher than predetermined safe levels. The Li/FeS₂ cell 10 has a typical OCV (open cell voltage) of about 1.8 volts and an average running voltage of between 1.2 and 1.5 volts in normal use, e.g., including use in a digital camera. Under normal usage the cell may withstand maximum current drain levels up to about 3 Amp maximum. In an abusive or abnormal situation, for example, short circuit drain, the current drain could possibly rise to or near 10 Amp within milliseconds. The PTC devise 160 is designed to activate and increases resistance therethrough at a dramatic rate under such conditions. This causes the current drain to abruptly drop to safe levels thereby protecting the cell. A suitable PTC device for use in an Li/FeS₂ cell 10 may have an initial resistivity (before exposed to high current drain) typically between about 7 and 8 ohm×mm.

The cell 10, which may be a primary Li/FeS₂ cell, may be assembled in the following manner:

An electrode assembly 213 is formed by spirally winding an anode sheet 240 and cathode composite 262 with separator sheet 250 therebetween. The initial layered configuration before winding is shown in FIG. 16 which shows a top separator layer 250 and underlying anode layer 240 and second separator layer 250 underlying said anode layer 240 and a cathode composite layer 262, which is cathode material 260 coated onto conductive substrate (carrier) 265, underlying said second separator layer 250. The wound electrode assembly 213 is desirably provided with an insulating sheet or cover 270 which is wrapped around the wound assembly. The wound electrode assembly 213 has a cathode tab 264 (FIG. 17) jutting out from the top of the wound electrodes and an anode tab 244 (FIG. 17) jutting out from the bottom of wound electrodes as shown also in FIG. 2.

In assembly the anode tab 244 is passed against the flat or truncated edge portion 172 of bottom insulating disk 170 (FIG. 2) so that it comes into contact with the underside of bottom insulating disk 170 when bent. The wound electrode assembly 213 is then inserted into casing 70 through open end 15. Anode tab 244 may then be welded to the inside surface of the casing 70 closed bottom 75 by laser welding from outside the cell. The insulating washer 150 is then inserted over the top end of wound electrode assembly 213 (FIG. 2). A circumferential bead 73 is formed on the casing body 74 near the open end 15 of the casing. The edge of insulating washer 150 snaps under the circumferential bead 73 so that it presses onto the top end of electrode assembly 213 and holds the wound electrode 213 in casing 70 as shown in FIG. 1. The cathode tab 264 juts out from the top end of the electrode assembly 213. (The main portion of cathode tab 264 may be wrapped on both sides in insulating sheet 248, typically of polypropylene, to protect tab 264 from inadvertent contact with anode material 240 or casing 70).

The cap assembly 14 is then formed in the following manner: A subassembly 14a may be formed first comprising cathode contact cup 40 with support washer 140, preferably of metal, inserted therein (FIG. 2). The cathode contact cup 40 is of metal and is characterized by having a cup shape having an integral closed base 49 with side walls or peripheral edge 48 surrounding said closed base 49 and extending therefrom. The base 49 may be flat as shown in FIG. 13 or recessed down from edge 48 as shown in FIG. 10. The base 49 of cathode contact cup 40 has grooves 44 therein forming underlying rupturable remaining metal portions 43. Examples of a cathode contact cup 40 having such grooves 44 with underlying rupturable remaining metal 43 are shown in FIGS. 6 and 7. As above described the remaining metal portions 43 underlying grooves 44 are designed to rupture if gas within the cell builds up a predetermined pressure level, thereby venting gas to the environment and reducing the cell's internal pressure.

Various configurations of the subassembly 14a comprising cathode contact cup 40 with metal support washer 140 (or equivalent) therein are possible. Three embodiments of subassembly 14a are provided herein by way of example. In the first embodiment a metal support washer 140 (FIG. 5) is inserted onto annular ledge 46 within cathode contact cup 40 (FIG. 6 or 7) and the peripheral edge 48 of said cathode contact cup 40 is crimped over the metal support washer 140 thereby locking it in place within the cup 40 to produce the crimped configuration shown in FIGS. 10 and 11, respectively.

In a second embodiment (single piece fabrication) shown in FIGS. 12 and 13 the base 49 of the cathode cup 40 is flat and a thick annular region 46a is integrally formed in cup 40. In this latter embodiment the separate metal support washer 140 has been eliminated. Instead the metal support washer thickness has been integrally built into the cathode cup 40 by employing a flat base 49 over the entire cup diameter and thickening the annular region 46a. The surface to surface interface between the cathode contact cup 40 (FIG. 13) and seal disk 20 (FIG. 13), and surface to surface interface between the can 70 (FIG. 13A) and seal disk 20 (FIG. 13A) may have mating surface irregularities or notches creating an upper pinch annulus 11 and lower pinch annulus 12 between the contact cup 40, seal disk 20 and can 70 as shown in FIG. 13A. The notched interfacial surfaces 41a and 21a between the cathode cup 40 and seal disk 20, respectively, as shown in FIG. 13A provides excellent interlocking between the contact cup 40 and seal disk 20. Also the pinch annuli 11 and 12 make it less likely that seal 20 can creep during cell assembly and cell usage. During crimping of casing 70 over seal 20 the portion of seal 20 between pinch annuli 11 and 12 is under compression and held trapped between the pinch annuli 11 and 12. This reduces the chance that cold creep can occur in seal 20. It also results in close interfacial contact between seal 20 and casing 70 and also results in close interfacial contact between seal 20 and cathode contact cup 40. Such close interfacial contact is maintained during cell storage and usage.

In a third embodiment (FIG. 15) there is utilized a thicker metal support disk as shown in FIG. 14 which is inserted onto ledge 46 of cathode contact cup 40 (FIG. 15). But since the metal support disk 140 is thicker than in the embodiment shown in FIG. 5, the peripheral edge 48 of the cathode contact cup 40 is not crimped over the surface edge 142 of said metal support disk 140 but rather the metal support disk 140 just fits snugly within the bounds of contact cup peripheral edge 48. The resulting subassembly 14a comprising said thicker metal support disk 140 (FIG. 14) within the non crimped cathode contact cup 40 is shown in FIG. 15.

Once the subassembly 14a comprising the cathode contact cup 40 and metal support disk 140 (or equivalent) is completed it may be inserted directly into the body of insulating sealing disk 20 so that at least a portion of base 49 of the cathode contact cup 40 is exposed. The cathode tab 264 may then be welded to base 49 by laser welding or equivalent. The PTC disk 160 is inserted within the insulating sealing disk 20 so that it rests on the contact cup edge 48 as shown in FIGS. 10, 11 , 13 or 15. Then end cap 60 is inserted into the insulating sealing disk 20 by snap fitting the edge 66 of end cap 60 over the circumferential protrusion 24 (FIG. 9) on insulating seal surface edge 28. This completes the formation of end cap assembly 14. Electrolyte may then be added to the spirally wound electrode assembly 213 within casing 70. The completed end cap assembly 14 is then inserted into open end 15 of casing 70. The bottom portion 28a of peripheral edge 28 of the insulating seal disk 20 rests on casing circumferential bead 73. In the process of inserting the end cap assembly 14 the body portion of cathode tab 264 becomes folded under the insulating seal 20, though the end of cathode tab 264 has already been welded to the bottom of cathode contact cup 40. At this stage the casing peripheral edge 72 is crimped over edge 28 of insulating seal disk 20 thus locking the end cap assembly 14 including end cap 60 tightly and securely in place and permanently closing cell casing 70. This crimping procedure also locks end cap 60 in place within the cell thereby making it tamper proof. Radial forces may also be applied during crimping to further secure the end cap assembly 14 within casing 70. The cell assembly is now complete and the cell is ready for use.

The following are suitable materials of construction for the above indicated components of cell 10 and end cap assembly 14, although it is not intended that the invention be necessarily limited to any particular materials:

The casing 70 may suitably be of nickel plated cold rolled steel of wall thickness typically between about 0.1 and 0.5 mm, preferably between 0.2 and 0.3 mm, for example about 0.25 mm. Alternatively, the casing 70 may be composed of aluminum, aluminum alloy, nickel, or stainless steel, or may include a plastic shell. The cathode contact cup 40 is preferably constructed of an aluminum alloy, in particular an aluminum alloy which has been heat treated (annealed) to make it more malleable. Suitable aluminum alloys for cathode contact cup 40 may be selected from the ASTM designated 1000 to 7000 series which have been subjected to heat treatment (annealing). A preferred aluminum alloy for cathode contact cup 40 is aluminum alloyed with magnesium and chromium, subjected to heat treatment (annealing), available under ASTM designation 5052-H38 or 5052-H34 as above described. The support washer 140 may desirably be of nickel plated cold rolled steel. Alternatively, support washer 140 may be of the same preferred composition as cathode contact cup 40, namely the above indicated aluminum alloys. The support washer 140 may have a wall thickness typically between about 0.1 and 1.5 mm, desirably between about 0.2 and 1.5 mm. Contact cup 40 may have wall thicknesses ranging typically between about 0.2 and 1.2 mm. End cap 60 may desirably be of nickel plated cold rolled steel having a wall thickness of between about 0.1 and 0.5 mm. The insulating sealing disk 20 for the lithium cell 10 is preferably of polypropylene but may be of other durable plastics including polyethylene, copolymers of polyethylene and copolymers of polypropylene, silicone rubber, and polybutyleneterephthalate, or other materials. Similarly the insulating disks 150 and 170 (FIG. 2) may be of same or comparable durable plastic material as that employed for insulating sealing disk 20. The insulating sheet or cover 270 protecting the wound electrode assembly 213 may also be of same or comparable plastic material as that employed for insulating sealing disk 20.

For a representative Li/FeS₂ primary (nonrechargeable) wound electrode cell 10 employing the end cap assembly 14 of the invention, the cathode coating 260 having the following dry content is initially mixed with a hydrocarbon solvents such as ShellSol A100 hydrocarbon solvent (Shell Chemical Co.) and Shell Sol OMS hydrocarbon solvent (Shell Chemical Co.). The mixture is applied to conductive substrate (carrier) 265 (FIG. 17) as a wet coating. The wet coating is then dried to form dry cathode coating 260 having the representative composition:

FeS₂ powder (89.0 wt. %); Binder Kraton G1651 elastomer from Kraton Polymers, Houston, Tex.) (3.0 wt. %); conductive carbon particles, high crystalline graphite Timrex KS6 from Timcal Ltd (7 wt. %) and carbon black, e.g., acetylene black (1 wt %). The dried cathode coating 260 adheres to conductive substrate 265 such as a foil or grid, preferably a sheet of aluminum, or stainless steel expanded metal foil to form the cathode composite 262 (FIG. 16).

Anode 240 may be a sheet of lithium metal (99.8% pure). Alternatively, the anode sheet 240 can be an alloy of lithium and an alloy metal, for example, an alloy of lithium and aluminum. In such case the alloy metal, is present in very small quantity, preferably less than 1 percent by weight of the lithium alloy. Thus the lithium alloy functions electrochemically nearly as pure lithium. The separator sheet 250 for the Li/FeS2 cell may be a microporous polypropylene.

The wound electrode assembly 213 comprising anode sheet 240, cathode composite 262 (cathode coating 260 on conductive substrate 265) with separator sheet 250 therebetween is formed and inserted into cell casing 70. A suitable electrolyte is then added to the electrode assembly 213 after it has been inserted into the cell casing 70. A desirable electrolyte is an electrolyte solution comprising 0.8 molar (0.8 mol/liter) Li(CF₃SO₂)₂N (LiTFSI) salt dissolved in an organic solvent mixture comprising about 75 vol. % methyl acetate (MA), 20 vol. % propylene carbonate (PC), and 5 vol. % ethylene carbonate (EC) as recited in commonly assigned U.S. patent application Ser. No. 11/516,534.

Although the present invention has been described with respect to specific embodiments, it should be appreciated that variations are possible within the concept of the invention. Accordingly, the invention is not intended to be limited to the specific embodiments but is within the claims and equivalents thereof.

What is claimed is:

1. An electrochemical cell having a housing having an open end an opposing closed end and cylindrical side wall therebetween and an end cap assembly inserted into the open end of said housing closing said housing, said cell having an anode, a cathode and separator therebetween, and a positive and a negative terminal,
wherein the end cap assembly comprises an insulating sealing disk and a cup comprising metal inserted within said insulating sealing disk; wherein said metal cup has an open end, an opposing closed end and integral side walls therebetween; wherein said metal cup has at least one groove on its closed end, said groove having an open end and opposing closed base wherein said base forms a thinned rupturable portion of remaining metal which ruptures when gas within the cell rises.

2. The cell of claim 1 wherein said cell is a primary nonrechargeable cell and the cathode is electrically connected to said positive terminal and the anode is electrically connected to said negative terminal; wherein said metal cup is electrically connected to said cathode.

3. The cell of claim 2 wherein said cathode has a conductive tab extending therefrom, wherein said conductive tab is joined to said metal cup.

4. The cell of claim 2 wherein said groove is of straight or curvilinear shape.

5. The cell of claim 1 wherein the end cap assembly further comprises and insulating sealing disk bounded by a peripheral edge; wherein said insulating sealing disk has an aperture running longitudinally through said insulating sealing disk thereby forming a pair of opposing open ends in said disk; wherein said metal cup is inserted into the interior of said insulating sealing disk within said aperture so that said metal cup is bounded by said insulating sealing disk peripheral edge.

6. The cell of claim 5 wherein there is interfacial contact between at least a portion of the insulating sealing disk and the metal cup, wherein said interfacial contact is interlocking.

7. The cell of claim 5 wherein the closed end of said metal cup comprising said groove is exposed to the cell interior through said aperture in the insulating sealing disk, so that gas from within the cell impinges against the thin rupturable portion of remaining metal at the base of said groove.

8. The cell of claim 7 wherein the portion of remaining metal at the base of said groove ruptures when the gas pressure within the cell builds to a level between about 50 psi and 1000 psi (345 and 6894 kilo pascal).

9. The cell of claim 8 wherein the remaining metal at the base of said groove comprises an alloy of aluminum and said remaining metal has a thickness of between about 0.02 and 0.12 mm.

10. The cell of claim 7 wherein the portion of remaining metal at the base of said groove ruptures when the gas pressure within the cell builds to a level between about 350 psi and 500 psi (2413 and 3447 kilo pascal).

11. The cell of claim 10 wherein the remaining metal at the base of said groove comprises an alloy of aluminum and said remaining metal has a thickness of between about 0.02 and 0.06 mm.

12. The cell of claim 7 wherein the end cap assembly further comprises a support washer inserted within said metal cup to enhance the strength of said metal cup, wherein said support washer has a central aperture therethrough.

13. The cell of claim 12 wherein said metal cup side walls are crimped over said support washer thereby locking said support washer in place within said metal cup.

14. The cell of claim 7 wherein a thickened annular region within the closed end of said metal cup is formed to enhance the strength of said metal cup.

15. The cell of claim 1 wherein said metal cup is comprised of an alloy of aluminum.

16. The cell of claim 7 wherein the end cap assembly further comprises an end cap over said metal cup when the cell is viewed in vertical position with the end cap assembly on top, wherein said end cap comprises metal and functions as the cell's positive terminal.

17. The cell of claim 1 wherein the end cap assembly further comprises a PTC (positive temperature coefficient) device between said end cap and said metal cup.

18. The cell of claim 16 wherein the edge of said housing at the open end thereof is crimped over the peripheral edge of said insulating sealing disk; whereby the peripheral edge of said insulating sealing disk in turn becomes crimped over the edge of said end cap and the edge of said metal cup thereby locking said end cap and metal cup in place within said insulating sealing disk and wherein said end cap assembly becomes locked in place within the open end of said housing thereby closing and sealing said housing.

19. The cell of claim 1 wherein said anode and cathode with separator therebetween are in the form of a wound spiral inserted into the cell housing.

20. The cell of claim 2 wherein said groove comprises a plurality of groove segments jutting out from a common point at the closed end of said metal cup, wherein said common point is displaced from the cell's central longitudinal axis.

21. The cell of claim 2 wherein said groove at the closed end of said metal cup runs circumferentially around the cell's central longitudinal axis.

22. The cell of claim 1 wherein the anode comprises lithium or lithium alloy and the cathode comprises iron disulfide (FeS₂).

23. An electrochemical cell having a housing having an open end an opposing closed end and cylindrical side wall therebetween and an end cap assembly inserted into the open end of said housing closing said housing, said cell having an anode comprising lithium or lithium alloy, a cathode comprising iron disulfide (FeS₂) and a separator therebetween, and a positive and a negative terminal; wherein said anode and cathode with separator therebetween are in the form of a wound spiral inserted into the cell housing;
wherein the end cap assembly comprises an insulating sealing disk and a cup comprising metal inserted within said insulating sealing disk; wherein said metal cup has an open end, an opposing closed end and integral side walls therebetween; wherein said metal cup has at least one groove on its closed end, said groove having an open end and opposing closed base wherein said base forms a thinned rupturable portion of remaining metal which ruptures when gas within the cell rises.

24. The cell of claim 23 wherein said cell is a primary nonrechargeable cell and the cathode is electrically connected to said positive terminal and the anode is electrically connected to said negative terminal; wherein said metal cup is electrically connected to said cathode.

25. The cell of claim 24 wherein said cathode has a conductive tab extending therefrom, wherein said conductive tab is joined to said metal cup.

26. The cell of claim 24 wherein said groove is of straight or curvilinear shape.

27. The cell of claim 23 wherein the end cap assembly further comprises and insulating sealing disk bounded by a peripheral edge; wherein said insulating sealing disk has an aperture running longitudinally through said insulating sealing disk thereby forming a pair of opposing open ends in said disk; wherein said metal cup is inserted into the interior of said insulating sealing disk within said aperture so that said metal cup is bounded by said insulating sealing disk peripheral edge.

28. The cell of claim 27 wherein there is interfacial contact between at least a portion of the insulating sealing disk and the metal cup, wherein said interfacial contact is interlocking.

29. The cell of claim 27 wherein the closed end of said metal cup comprising said groove is exposed to the cell interior through said aperture in the insulating sealing disk, so that gas from within the cell impinges against the thin rupturable portion of remaining metal at the base of said groove.

30. The cell of claim 29 wherein the portion of remaining metal at the base of said groove ruptures when the gas pressure within the cell builds to a level between about 50 psi and 1000 psi (345 and 6894 kilo pascal).

31. The cell of claim 30 wherein the remaining metal at the base of said groove comprises an alloy of aluminum and said remaining metal has a thickness of between about 0.02 and 0.12 mm.

32. The cell of claim 29 wherein the portion of remaining metal at the base of said groove ruptures when the gas pressure within the cell builds to a level between about 350 psi and 500 psi (2413 and 3447 kilo pascal).

33. The cell of claim 32 wherein the remaining metal at the base of said groove comprises an alloy of aluminum and said remaining metal has a thickness of between about 0.02 and 0.06 mm.

34. The cell of claim 29 wherein the end cap assembly further comprises a support washer inserted within said metal cup to enhance the strength of said metal cup, wherein said support washer has a central aperture therethrough.

35. The cell of claim 34 wherein said metal cup side walls are crimped over said support washer thereby locking said support washer in place within said metal cup.

36. The cell of claim 31 wherein a thickened annular region within the closed end of said metal cup is formed to enhance the strength of said metal cup.

37. The cell of claim 25 wherein said metal cup is comprised of an alloy of aluminum.

38. The cell of claim 31 wherein the end cap assembly further comprises an end cap over said metal cup when the cell is viewed in vertical position with the end cap assembly on top, wherein said end cap comprises metal and functions as the cell's positive terminal.

39. The cell of claim 24 wherein the end cap assembly further comprises a PTC (positive temperature coefficient) device between said end cap and said metal cup.

40. The cell of claim 39 wherein the edge of said housing at the open end thereof is crimped over the peripheral edge of said insulating sealing disk; whereby the peripheral edge of said insulating sealing disk in turn becomes crimped over the edge of said end cap and the edge of said metal cup thereby locking said end cap and metal cup in place within said insulating sealing disk and wherein said end cap assembly becomes locked in place within the open end of said housing thereby closing and sealing said housing.

41. The cell of claim 24 wherein said groove comprises a plurality of groove segments jutting out from a common point at the closed end of said metal cup, wherein said common point is displaced from the cell's central longitudinal axis.

42. The cell of claim 24 wherein said groove at the closed end of said metal cup runs circumferentially around the cell's central longitudinal axis.
